(19) United States
(12) Patent Application Publication
(10) Pub. No.: US 2016/0249303 A1
(43) Pub. Date: Aug. 25, 2016

(54) Power Control for High Efficiency Wireless Local Area Network

(71) Applicants: Thomas J. Kenney, Portland, OR (US); Chittabrata Ghosh, Fremong, CA (US); Shahrnaz Azizi, Cupertino, CA (US); Eldad Perahia, Portland, OR (US)

(72) Inventors: Thomas J. Kenney, Portland, OR (US); Chittabrata Ghosh, Fremong, CA (US); Shahrnaz Azizi, Cupertino, CA (US); Eldad Perahia, Portland, OR (US)

(21) Appl. No.: 14/744,702

(22) Filed: Jun. 19, 2015

Related U.S. Application Data
(60) Provisional application No. 62/118,876, filed on Feb. 20, 2015.

(51) Int. Cl. H04W 52/24; H04W 24/08

(52) U.S. Cl. CPC H04W 52/248; H04W 24/08; H04W 84/12

(57) ABSTRACT

This disclosure describes methods, device, and systems related to power control. A first device comprising one or more processors and one or more transceiver components may identify a trigger frame received from a second device, the trigger frame comprising one or more fields. The first device may select a resource unit of an operating channel in accordance with Orthogonal Frequency-Division Multiple Access (OFDMA) standard. The first device may measure a power level of a first field of the trigger frame. The first device may determine a transmit power level based at least in part on measuring the power level of the first field. The first device may cause to send to the second device, one or more signals based at least in part on the transmit power level. The methods, apparatus, and systems described herein can be applied to 802.11ax or any other wireless standard.

### CROSS-REFERENCE TO RELATED APPLICATIONS

This application claims priority to U.S. Provisional Patent Application No. 62/118,876, entitled “Random Access Power Control For High Efficiency WLAN,” filed on Feb. 20, 2015, which is incorporated here by reference in its entirety.

### TECHNICAL FIELD

This disclosure generally relates to systems and methods for wireless communications and, more particularly, to power control.

### BACKGROUND

Wireless devices are becoming widely prevalent and are increasingly requesting access to wireless channels. A next generation High-Efficiency WLAN (HEW) is under development. HEW Wireless devices may utilize Orthogonal Frequency-Division Multiple Access (OFDMA) to access wireless channels to send and receive data. Further, these devices may transmit data at different power levels and/or may be at different distances from an access point.

### BRIEF DESCRIPTION OF THE DRAWINGS

FIG. 1 depicts a network diagram illustrating an example network environment of an illustrative power control system, according to one or more example embodiments of the disclosure;

FIG. 2 depicts an illustrative schematic diagram between components of an illustrative power control system, in accordance with one or more example embodiments of the present disclosure;

FIG. 3 depicts an example preamble structure in accordance with IEEE 802.11ax;

FIG. 4 depicts an example preamble structure in accordance with IEEE 802.11ax;

FIG. 5 depicts a flow diagram of an illustrative process for an illustrative power control system, in accordance with one or more embodiments of the disclosure;

FIG. 6 illustrates a functional diagram of an example user device or example access point, according to one or more example embodiments of the disclosure; and

FIG. 7 shows a block diagram of an example of a machine upon which any of one or more techniques (e.g., methods) according to one or more embodiments of the disclosure discussed herein may be performed.

### DETAILED DESCRIPTION

Example embodiments described herein provide certain systems, methods, and devices, for power control between Wi-Fi devices in various Wi-Fi networks, including, but not limited to, IEEE 802.11ax (HEW).

In HEW, user devices may communicate with other user devices and/or access points in a scheduled or unscheduled (random) manner. In the scheduled manner, an access point may allocate and assign network resources to the user devices in order to transmit their data. In the alternative, user devices may randomly access the operating channel to transmit their data. Utilizing the trigger frame of HEW, the access point may send either a trigger frame indicating that one or more user devices are assigned scheduled resource units, or may send a random access trigger frame indicating that resource units are available in a random access manner, where user devices randomly select one or more resource units. The trigger frame may be associated with one or more resources units on an operating channel. When a user device detects the trigger frame, it may use one of the one or more resource units associated with the trigger frame to send its uplink data.

In some embodiments of the disclosure, an HEW user device may perform power measurements before transmitting its data using one or more resource units associated with a detected trigger frame in order to determine an estimated transmit power level for sending the uplink data. For example, the user device may measure the power level of one or more received signals in order to estimate a power level at which the user device may transmit data. The transmit power is the power level that may be used by the user device to transmit its uplink data to another user device and/or an access point.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The word “exemplary” is used herein to mean “serving as an example, instance, or illustration.” Any embodiment described herein as “exemplary” is not necessarily to be construed as preferred or advantageous over other embodiments. The terms “computing device”, “communication station”, “station” (also referred to as STA), “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, a user equipment (UE), a wireless communication device, or some other similar terminology known in the art. Embodiments disclosed herein generally pertain to wireless networks. Some embodiments can relate to wireless networks that operate in accordance with one of the IEEE 802.11 standards including the IEEE 802.11ax standard.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

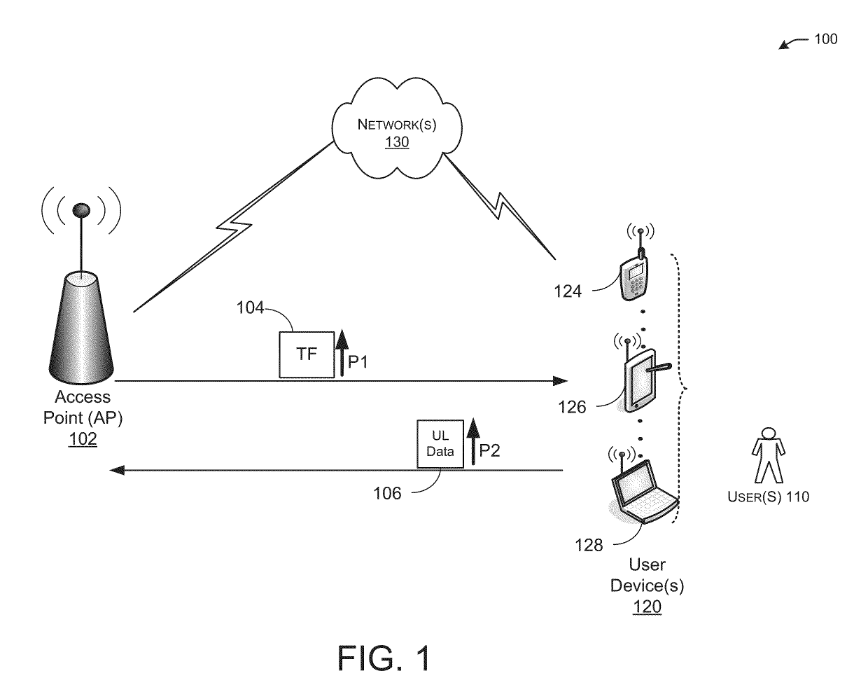

FIG. 1 is a network diagram illustrating an example wireless network 100 for power control system, according to some example embodiments of the present disclosure.—Systems and methods in accordance with various embodiments of the present disclosure provide the ability for a user device, including an HEW user device, to perform power measurements before transmitting its data. For example, the user device may measure the power level of one or more received signals in order to estimate a power level at which the user device may transmit data.

The transmit power is the power level that may be used by the user device to transmit its uplink data to another user device and/or an access point. For example, an access point may send a trigger frame (e.g., TF 104) to one or more HEW devices (e.g., user devices 124, 126, 128) indicating that these devices are allowed to transmit their uplink data using one or more resources on an operating channel. The operating channel may be a channel that may be established between a user device and an access point. A trigger frame may be simply a frame that contains a preamble and other fields that may be sent from an access point (e.g., AP 102) that informs HEW user devices (e.g., user device 120) serviced by the access point that channel access is available. The HEW devices having data to send to the access point may first wait until they detect the trigger frame (e.g., TF 104) before sending their uplink data. These user devices may measure the power level of one or more of the fields, where the one or more fields may be included in the preamble or other parts of the trigger frame. For example, the power level of one or more fields of the trigger frame when received by the user device may be designated as P1. It is understood that the power level may be represented in decibel or dB. By performing the power measurement at the user device 120 (e.g., 124, 126 or 128), the user device may identify or estimate a power level to transmit at based on the performed power measurement. In this example, the measurement of the power level P1 may result in a transmission power level P2. P1 and P2 may have substantially similar values. The values of P1 and P2 may differ based at least in part on one or more factors such as noise, interference, or other factors may affect the power measurement of the received trigger frame at the user device.

In some embodiments, the determined or estimated transmit power that may not be sufficient for the data to reach the operating channel with enough power to be received and decoded due to interference or noise or other factors. In that case, the user device would not receive an acknowledgement or the like, and may make the determination the transmitted signal was not received. The user device may then boost its determined transmit power, where the amount of power boost may be predetermined by the network, the system, a system administrator, the user device, etc.

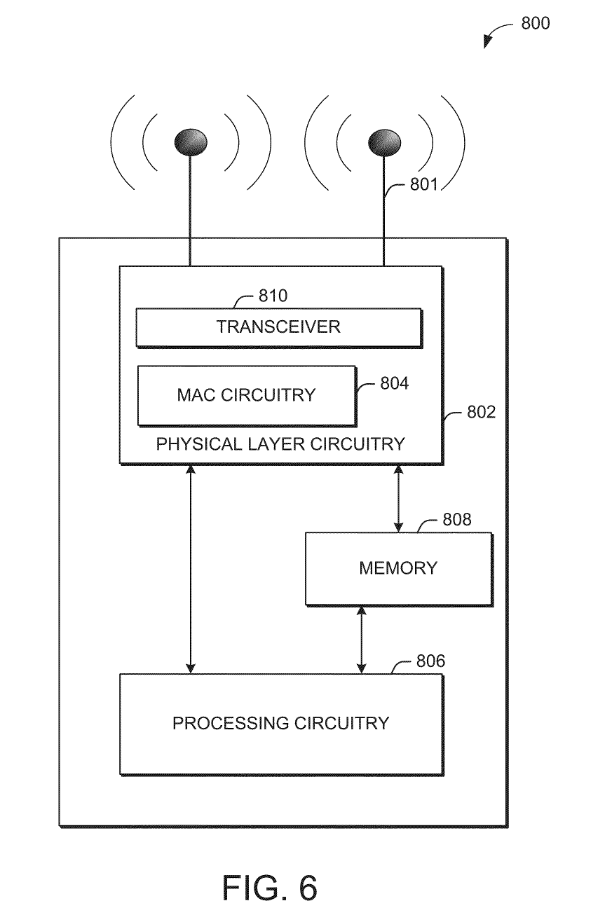

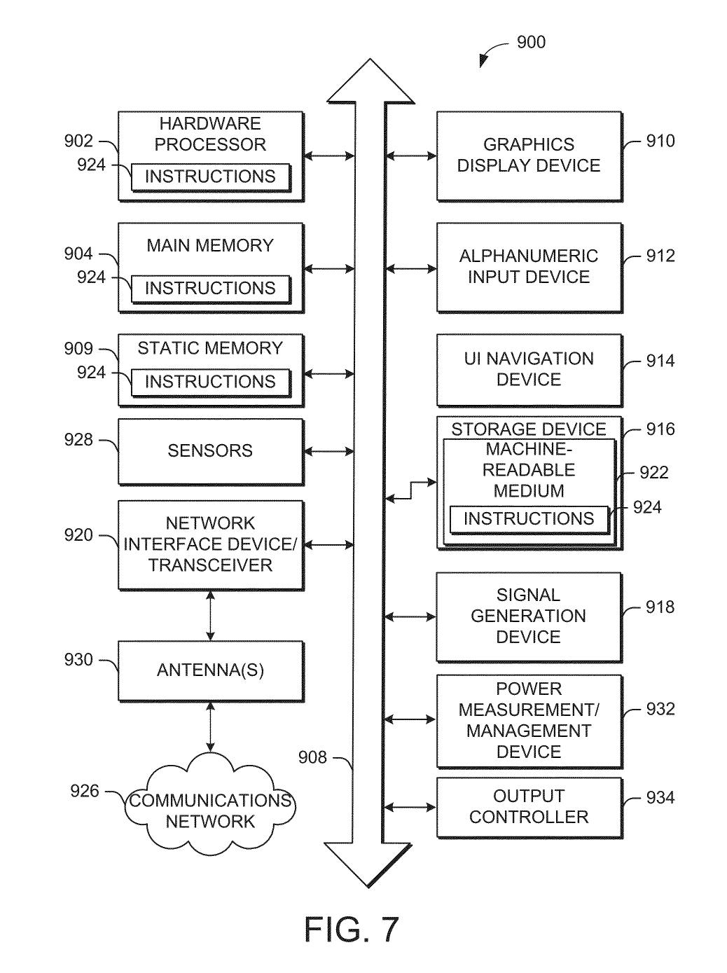

The illustrative wireless network 100 can include one or more user devices 120 and one or more access point(s) (AP) 102, which may communicate in accordance with IEEE 802.11 communication standards, including IEEE 802.11ax. The user device(s) 120 and the one or more AP 102 may be devices that are non-stationary without fixed locations or may be stationary with fixed locations. In some embodiments, the user devices 120 and AP 102 can include one or more computer systems similar to that of the functional diagram of FIG. 6 and/or the example machine/system of FIG. 7.

A design target for HEW is to adopt methods to improve the efficiency of Wi-Fi, and specifically the efficiency in dense deployments of Wi-Fi devices (e.g., user devices 120 and/or AP 102), such as in malls, conference halls, etc. HEW may use OFDMA techniques for channel access in the uplink and downlink directions. It is understood that the uplink direction is from a user device 120 to AP 102, and the downlink direction is from AP 102 to one or more user devices 120. In the uplink direction, one or more user devices may be communicating with the AP 102 and may be competing for channel access in a random channel access manner. In that case, the channel access in OFDMA may require coordination among the various user devices 120 who may be competing to access the operating channel simultaneously.

In one embodiment, a power control system may enable random access to an operating channel within a Wi-Fi protocol, including HEW. For example, user devices 120 may randomly access the operating channel by selecting a resource unit after receiving a trigger frame from an access point, where the trigger frame is designated for random access. It is understood that a resource unit may be bandwidth allocation on an operating channel in time and/or frequency domain. For example, in a frequency band of 20 MHz, there may be a total of 9 resources units, each the size of a basic resource unit of 26 frequency tones.

Since user devices 120 may have different power levels based on various factors, and may be at different distances from the AP 102, one user device 120 may overpower another user device 120 such that signals from the other user devices 120 may be lost or may be noisy. The differences in power as seen at the AP 102 between the resource units utilized by one or more user devices 120 may be substantial. Therefore, one or more user devices 120 could saturate the AP 102 to a point where the signals from the other user devices 120 are not distinguishable.

Additionally, user devices 120 with assigned resource units at the edge of a frequency band (e.g., 20/40/80 MHz) could be degraded significantly if there is another user device 120 operating on an adjacent frequency band (e.g., 20/40/80 MHz), with much higher power, as seen at the AP 102.

The trigger frame concept was introduced in HEW to enable OFDMA operation. This trigger frame may consist of a preamble, along with other signaling, like resource allocation, to coordinate the uplink OFDMA operation. The AP 102 may send a TF 104 to one or more user devices 120 indicating that resource units are available. The user devices 120 may detect the TF 104 and based on that may send their uplink data (e.g., UL Data 106) to the AP 102.

In accordance with some IEEE 802.11ax (HEW) embodiments, an AP may operate as a master station which may be arranged to contend for a wireless medium (e.g., during a contention period) to receive exclusive control of the medium for an HEW control period. The master station may transmit an HEW master-sync transmission at the beginning of the HEW control period. During the HEW control period, HEW stations (e.g., user devices 120) may communicate with the master station in accordance with a non-contention based multiple access technique. This is unlike conventional Wi-Fi communications in which devices communicate in accordance with a contention-based communication technique, rather than a multiple access technique. During the HEW control period, the master station may communicate with HEW stations using one or more HEW frames. Furthermore, during the HEW control period, legacy stations refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique, although this is not a requirement. In other embodiments, the multiple access technique may be a time-division multiple access (TDMA) technique or a frequency division multiple access (FDMA) technique. In certain embodiments, the multiple access technique may be a space-division multiple access (SDMA) technique.

The master station may also communicate with legacy stations in accordance with legacy IEEE 802.11 communication techniques. In some embodiments, the master station may also be configurable to communicate with HEW stations outside the HEW control period in accordance with legacy IEEE 802.11 communication techniques, although this is not a requirement.

One or more illustrative user device(s) 120 may be operable by one or more users 110. The user device(s) 120 may include any suitable processor-driven user device including, but not limited to, a desktop computing device, a laptop computing device, a server, a router, a switch, a smartphone, a tablet, wearable wireless device (e.g., bracelet, watch, glasses, ring, etc.) and so forth.

Any of the user device(s) 120 (e.g., user devices 124, 126, 128), and AP 102 may be configured to communicate with each other via one or more communications networks 130 wirelessly or wired. In the alternative, any of the user device(s) 120 (e.g., user devices 124, 126, 128), and AP 102 may be configured to communicate with each other directly. Any of the communications networks 130 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennae. Communications antenna may be any suitable type of antenna corresponding to the communications protocols used by the user device(s) 120 (e.g., user devices 124, 126 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

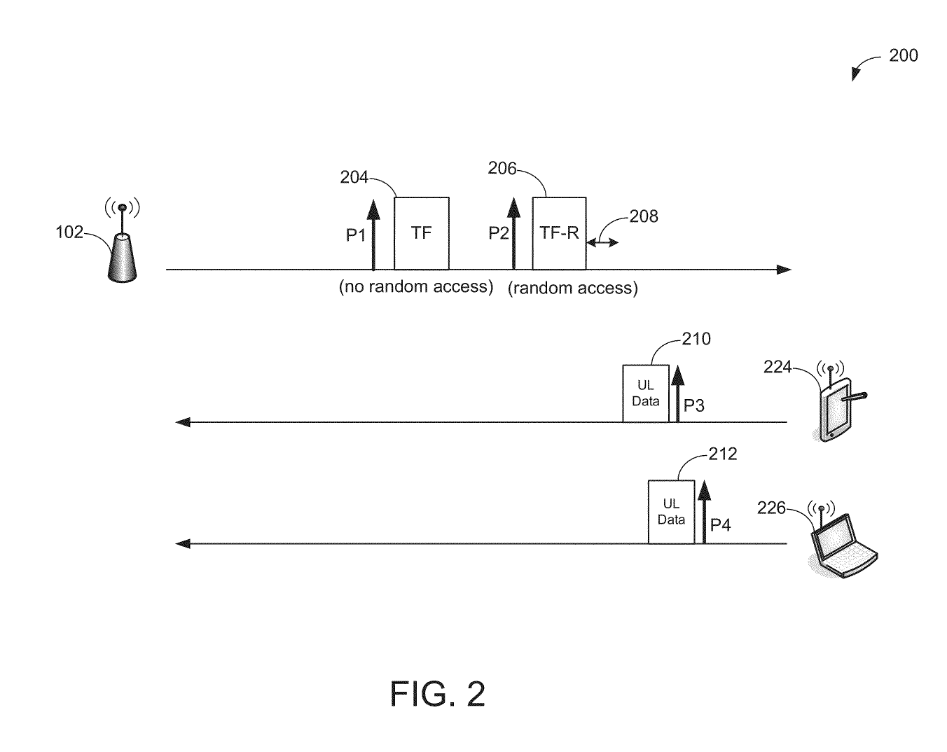

FIG. 2 depicts an illustrative schematic diagram of scheduling channel access for one or more user devices (e.g., user devices 224 and 226), in accordance with one or more embodiments of the disclosure. For example, access to one or more operating channels by user devices 224 and 226 may be done in a scheduled and/or unscheduled manner. An AP, such as AP 102, may utilize trigger frames to provide channel access for the one or more user device 120. A trigger frame indicates to the user devices 120 that resource units for channel access are available. The trigger frame may reference one or more resource units that may be available for the user devices 120 to use for transmitting data in the uplink direction. The trigger frame may be a frame that contains a preamble and other fields that may be sent from an AP 102 informing all user devices 120 that are serviced by AP 102 that channel access is available.

In one embodiment, an AP (e.g., AP 102) may contend for a medium (e.g., a channel) and once the AP secures access, it may send a trigger frame (e.g., TF 204) or random access trigger frame (e.g., TF-R 206) to all user devices 120 identifying the exchange as an OFDMA exchange, and signaling the devices to participate in the uplink OFDMA transmission, and facilitating the scheduling of resource units for channel access (either scheduled or random). The AP 102 may send either a TF 204—indicating a that one or more user devices 120 have scheduled resource units, or a TF-R 206—indicating that resource units are available in a random access manner. When the user devices 120 detect the trigger frame (e.g., TF 204, and/or TF-R 206), the user devices 120 may then determine whether they have been assigned a resource unit (e.g., detecting TF 204) to transmit their data on an operating channel or whether they must compete for channel access (e.g., when detecting TF-R 206).

In one embodiment, the AP 102 may transmit a TF-R 206 to indicate that HEW user devices (e.g., 224 and 226) may use random access to select one or more resource units in order to transmit their uplink data. Before sending any uplink data, a may delay transmission by a predetermined channel access delay (e.g., 208). The channel access delay 208 may include various durations; for example, inter space frames (IFS) that corresponds to an interval of time between the issuance of two frames. It is understood that IFS may have various types of intervals according to the various wireless standards. For example, according to the IEEE 802.11 standards, IFS may have three types: 1) short IFS (SIFS), which is the minimum time between the last symbol of a frame and the beginning of the first symbol of the next frame; 2) distributed coordination function IFS (DIFS), which may be used when a station wants to initiate a communication; and 3) point coordination function IFS (PIFS), which may be used by an access point (AP) to perform polling. The channel access delay 208 may be set automatically by the system or may be set by the administrator or by a user on the system. It is understood that the channel access delay 208 may follow communications standards, such as IEEE 802.11 standards and its various provisions, including HEW.

After a channel access delay (e.g., SIFS, DIFS, PIFS, etc.) of detecting the TF transmission, one or more user devices (e.g., 224 and/or 226) may transmit its uplink data. However, as explained above, based on the power levels of one or more user devices 120 and/or their distance to AP 102, some user devices 120 may overpower other user devices 120 causing signal loss and/or noisy connection. It is understood that the above are only examples of two user devices attempting to access an operating channel and that other user devices may also attempt access to an operating channel.

In one embodiment, a power control system may employ an open loop power control mechanism to mitigate the discrepancy in power levels and/or the distance to AP 102. In open loop power control, a device may use instantaneous power measurement in order to determine the power level at which to transmit. For example, a user device may measure the power level of signals received from other devices such as an access point in order to estimate and adjust a transmit power that the user device may use for transmitting its data.

In one embodiment, a power control system may measure a received signal strength indicator (RSSI), and/or may measure a power level of one or more fields contained in the trigger frames in order to estimate the power level that the user device 120 may transmit at when transmitting its uplink data in order to restrict power asymmetry between the one or more user devices 120. It is understood that RSSI is a measurement of the power present in a received radio signal. In another embodiment, a power control system may adapt the transmit power, for example, by boosting the transmit power in case a user device 120 was unable to gain access the operating channel due to being denied service.

In random access, user devices 120 may select random resource units within an assigned frequency band (e.g., 20/40/80 MHz) and there may be a non-zero probability of multiple user devices 120 selecting the same resource unit prior to their respective uplink data transmissions. For example when TF-R 206 is detected by user devices 224 and 226, these devices may select the same resource unit (e.g., time or frequency) to simultaneously send their uplink data (e.g., UL data 210 and 212, respectively). With multiple user devices 120 selecting the same resource unit may result in collision, and in turn, may affect the received collective power at the AP 102. Consequently, an increased energy on a resource unit within the indicated frequency band (e.g., 20/40/80 MHz) may corrupt an adjacent frequency band (e.g., 20/40/80 MHz) transmission from a user device 120 that may be farther from the AP 102 or a packet from a low power user device 120 to the AP 102.

Typically, low power (e.g., 10 dBm) user devices located far from the AP (e.g., 20 dBm), may lead to the inability of closing links between a transmitting device (e.g., user device 224 and 22) and a receiving device (e.g., AP 102). The AP 102 may not be able to discern uplink transmissions from such user devices because of possible power asymmetry. A user device can select, or could be assigned, a resource unit within the OFDMA bandwidth to access an operating channel. For example, user device (e.g., 224, 226) may utilize OFDMA for random access to a channel when the user device detects a TF-R 206 sent by an AP 102. As explained above, this type of access may include user devices utilizing varying transmit power levels (based on the class of device or other features), and/or at differing distances from the AP 102. Without some mechanism to control the individual power of these devices, the collective power from user devices 120 trying to gain access to the operating channel, as seen at the AP 102, could be substantial. This would result in cases where one or more user devices could saturate the receiver (e.g., AP 102). This may result with lower power devices, on other adjacent resource allocations, having severely degraded performance. In a limiting case, a device may not even be able to attain access.

In one embodiment, the power control system may exploit the trigger frame concept to enable an open loop power control mechanism across all HEW user devices attempting channel access during the random access exchange. The power control system may measure the power level of one or more parts of the legacy portion of the preamble as the basis of setting the transmit power at each of the respective user devices. In other systems, such as many cellular systems, full duplex is used whereby the uplink and downlink channels are offset by some fixed separation (i.e., 45 MHz). In Wi-Fi, and specifically with HEW, the same channel may be used for both directions of the link, and with the trigger frame of HEW, the response from the user devices is within a short duration. Therefore, the channel may be highly correlated from the time of the trigger frame until the response from the user devices exploiting this reciprocity of the Wi-Fi channel, and using the legacy portion of the preamble provides a consistent, single stream signal from which all devices may base their transmit power. Although in this embodiment, the legacy portion is used, this is not to be construed as limiting since other portions may be utilized as well to improve the power estimate. It is understood that currently, the full structure of the preamble for the trigger frame has not been solidified in the HEW standard. Therefore, any changes or adoption of the standard may utilize the above concept to incorporate any of the finalized elements of the trigger frame structure including training and signal fields.

In another embodiment, each user device (e.g., user devices 224 and 226) wishing to participate in the random access exchange, may measure a defined portion of the trigger frame to estimate the received power. The user device may measure the power over the full frequency band (e.g., 20/40/80 MHz), or over the bandwidth covered by the received preamble. Additionally, as another option, it could also measure the power over the OFDMA resource allocation it chooses (or is assigned).

In one embodiment, a power control system may use one or more fields included in the preamble of the trigger frame to arrive at a measurement referred to herein as a coherent power measurement. In another embodiment, a power control system may measure the power using a RSSI type measurement, herein referred to as non-coherent power measurement. In yet another embodiment, the power control system may measure other portions of the trigger frame such as the payload. This measurement may help a user device (e.g., 224 and 226) determine at what power level to transmit. It is understood that these are only example mechanisms to measure the power level and that other mechanisms may be employed. For example, TF 204 may include a preamble that may contain one or more fields. The receiving device (e.g., 224 and/or 226) may measure the power level of at least one of the one or more fields included in the received preamble of the trigger frame.

In an embodiment, the user device (e.g., 224 and/or 226) may compute a transmit power based on the power it measured when it received a trigger frame and/or based on estimating the path loss. Unlike full duplex cellular systems, large margins for things such as fading and shadowing are not required. Thus, the system would need to have performance requirements placed on devices wishing to participate in an HEW random access protocol exchange. Systems not wanting to participate would not be required to meet these requirements. For example, a requirement may be to have a user device measure a received signal. The user device (e.g., 224 and/or 226) either selects a random OFDMA resource unit or is assigned by the AP 102 and it computes the transmit power on the assigned or selected resource unit based on received power and corresponding power spectral density (over basic resource unit). After Short Interframe Space (SIFS) time of trigger frame transmission, the user device (e.g., 224 and/or 226) may transmit a response within some power tolerance of the nominal value of the power measurement computed using the trigger frame.

In one embodiment, a power control system may employ an open loop power control mechanism to remedy the situation when user devices (e.g., 224 and/or 226) use assigned resource units at the edge of a frequency band (e.g., 20/40/80 MHz) if a device operating on an adjacent frequency band (e.g., 20/40/80 MHz) at a much higher power as seen at the receiver (e.g., AP 102). For example, a power control system may allow user devices (e.g., 224 and/or 226) participating in the random access exchange to measure adjacent channels if they are going to be assigned (or choose) a resource unit allocation at the band edges of, for example, a 20 KHz band. Based on that power measurement (again either coherent or non-coherent measurements is possible), those devices operating on resource units at the band edges, are allowed to add an additional power boost to their transmit signal. The amount of the boost could be set based on the out of band measurement, and or, based on a signal or predefined offset.

In one embodiment, to protect devices from being potentially locked out of the random access exchange due to errors in measurements, a power boost mechanism may be utilized by devices operating in adjacent resources. For example, if a device attempts to randomly access a channel in accordance with one or more embodiments of this disclosure but was unable to access the channel, then a power boost mechanism may be used. Basically, if the user devices (e.g., 224 and/or 226) with scheduled resource allocations do not receive an Acknowledgment (ACK)/Block acknowledgement (BA), it could be either due to a collision from third-party devices, or due to the signal not being received for high collective received power from multiple devices performing random access in an adjacent channel or sub-channel. Thus, on future attempts the user device (e.g., 224 and/or 226) would be backed off based on the protocol (e.g., IEEE 802.11), but could also be allowed to boost its transmit power, above what it computed based on the trigger frame measurement, on subsequent attempts. The amount of the power boost could be signaled, or fixed. A signaled power boost may be received from the AP 102 and a fixed power boost may be predetermined such that a power boost of a certain dB may be implemented. For example, if user device 224 is operating on an adjacent channel relative to user device 226, and if user device 224 attempted to access an operation channel but failed due to one or more of the above reasons, user device 224 may boost its transmit power in subsequent attempts. Additionally, the number of power boost steps allowed could be limited. For example, a user device 120 may only be allowed to implement a number of power boost up to a threshold, such that, if after those attempts the user device (e.g., 224 and/or 226) was unable to access the channel, power boosting is discontinued and the attempt by the user device (e.g., 224 and/or 226) to transmit its data may be considered as failed. This allows the device to have higher probability on successive transmissions without having an unlimited number of power boosts. It is understood that the above are only examples and that other ways to implement a power boost mechanism may be employed.

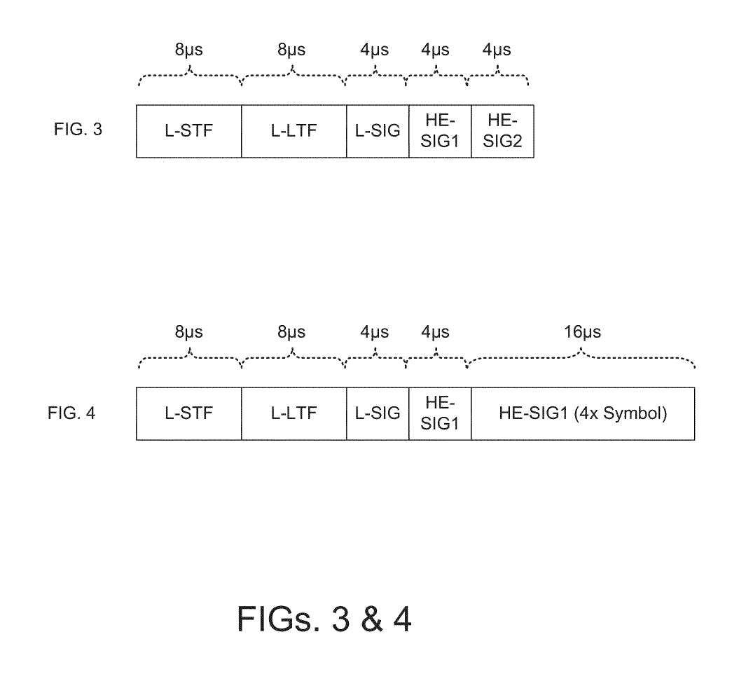

FIG. 3 illustrates an example preamble structure that may exist in the HEW standard. One possible example of an HEW preamble may include a legacy short training field (L-STF), a legacy long training field (L-LTF), a legacy signal field (L-SIG), a high efficiency signal field 1 (HE-SIG1) and high efficiency signal field 2 (HE-SIG2). The HEW preamble may contain the same sub-carrier spacing as in previous 802.11 systems. It is understood that this is an example of possible HEW preamble and that other examples may be possible.

FIG. 4 illustrates an example preamble structure that may exist in the HEW standard. One possible example of an HEW preamble may include a legacy short training field (L-STF), a legacy long training field (L-LTF), a legacy signal field (L-SIG), a high efficiency signal field 1 (HE-SIG1) and four symbols of the HE-SIG1. The HEW preamble may contain a sub-carrier spacing ¼ of that in previous 802.11 systems. It is understood that this is an example of possible HEW preamble and that other examples may be possible.

In an example, whenever the AP 102 contends and gains access to a channel, the AP 102 may send one or more trigger frames, which may include the example preamble structure of FIG. 3 of FIG. 4. The AP 102 transmits the trigger frames at determined power level that may be appropriate for the AP 102 and the user devices 120 it services. The user devices 120 may detect the one or more trigger frames and may determine whether they have been assigned a scheduled resource unit and whether they could utilize a resource unit for a random access to the channel. Before transmitting their uplink data Uplink data, the user devices 120 may measure the power level of one or more fields included in the preamble of the trigger frame (e.g., preamble structures of FIG. 3 or FIG. 4). Based on that measurement, the user devices 120 may adjust the power level for transmitting their uplink data. It is understood that the above is only an example of measuring the power level and other measurements may be possible. For example, the user devices 120 may measure the power level over the full frequency band (e.g., 20/40/80 MHz), or over the bandwidth covered by the received preamble. Additionally, as another option, it could also measure the power over the OFDMA resource allocation it chooses (or is assigned).

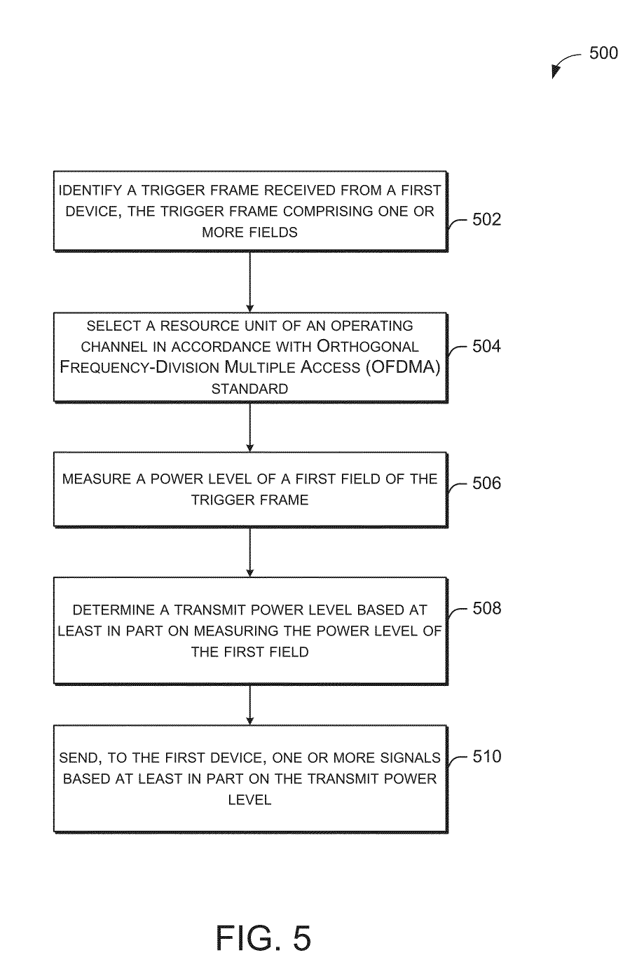

FIG. 5 illustrates a flow diagram of illustrative process 500 for a power control system in accordance with one or more embodiments of the disclosure.

At block 502, user device 120 or an AP 102 may identify a trigger frame received from a computing device, the trigger frame comprising one or more fields. For example, an AP 102 may first setup an operating channel between at least one user device 120. The AP 102 may gain access to the operating channel and may transmit data in the downlink direction to the at least one user device 120. The AP may then schedule the transmission of one or more trigger frames on the operating channel such that any of user device 120 may be able to identify the trigger frame received from AP 102. Each trigger frame consists of a preamble among other signaling fields. The trigger frame may be used to coordinate the uplink data that may be transmitted from one or more user devices 120. However, two or more user devices 120 may contend to access the operating channel simultaneously, for example, when random access trigger frame (e.g., TF-R) was identified. A TF-R indicates to the user devices 120 that each of the user devices 120 may randomly transmit its uplink data using available resource units.

At block 504, user device 120 or AP 102 may select a resource unit of an operating channel in accordance with Orthogonal Frequency-Division Multiple Access (OFDMA) standard. For example, HEW may use OFDMA techniques for channel access in the uplink and downlink directions. AP 102 may assign one or more resource units to user devices 120 or may allow the user devices 120 to randomly access an operating channel. It is understood that the resource unit may be bandwidth allocation on an operating channel in time and/or frequency domain. The one or more resource units allow the user devices 120 to send their uplink data using these specific resource units, for example, at a certain frequency and/or at a time.

At block 506, user device 120 or AP 102 may measure a power level of a first field of the trigger frame. Each trigger frame consists of a preamble that may contain fields such as L-STF, L-LTF, HE-STF, HE-LTF, and other signal fields. Signal fields may be for example, L-SIG, HE-SIG1, HE-SIG2, or any other variation of these signal fields. It is understood that the names and functions of the above fields are only examples and that other designations may be utilized. Whenever a user device 120 identifies a trigger frame (either a TF or a TF-R), the user device 120 may utilize a portion of the trigger frame to measure the power level of that portion. For example, the user device 120 may measure the power level of the L-STF field. It may also measure the power level of other fields in the trigger frame. Further, the user device 120 may measure the power level over a certain time or frequency range. For example, the user device 120 may measure the power level over a certain frequency band (e.g., 20 MHz, 40 MHz, or 80 MHz, etc.) or may measure the power level over the bandwidth covered by the received trigger frame. In another example, the user device 120 may measure the power using a RSSI, which is a measurement of the power present in a received radio signal. It is understood that the above is only for illustrative purposes and that other means for measuring the power level associated with a trigger frame may be employed.

At block 508, user device 120 or AP 102 may determine a transmit power level based at least in part on measuring the power level of the first field. For example, a user device 120 may compute a transmit power based on the receive power it measured. A transmit power is the power level that the user device 120 may transmit its uplink data. The estimation of the transmit power using the trigger frame provides a way to minimize the asymmetry of power levels for user devices 120 that would have had lower power or that are located at a far distance from the AP 102.

At block 510, user device 120 or AP 102 may send, one or more signals based at least in part on the transmit power level. For example, when a user device 120 measure the transmit power, it may utilize that information to transmit its uplink data at that transmit power level. After a backoff time (e.g., SIFS) of detecting the trigger frame transmission, the user device 120 may transmit its uplink data within some power tolerance of the nominal value of the power measurement computed using the trigger frame. It is understood that the above is only an example and not to be construed as a limitation.

FIG. 6 shows a functional diagram of an exemplary communication station 800 in accordance with some embodiments. In one embodiment, FIG. 6 illustrates a functional block diagram of a communication station that may be suitable for use as an AP 102 (FIG. 1) or communication station user device 120 (FIG. 1) in accordance with some embodiments. The communication station 800 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 800 may include physical layer circuitry 802 having a transceiver 810 for transmitting and receiving signals to and from other communication stations using one or more antennas 801. The physical layer circuitry 802 may also include medium access control (MAC) circuitry 804 for controlling access to the wireless medium. The communication station 800 may also include processing circuitry 806 and memory 808 arranged to perform the operations described herein. In some embodiments, the physical layer circuitry 802 and the processing circuitry 806 may be configured to perform operations detailed in FIGS. 2-5.

In accordance with some embodiments, the MAC circuitry 804 may be arranged to contend for a wireless medium and configure frames or packets for communicating over the wireless medium and the physical layer circuitry 802 may be arranged to transmit and receive signals. The physical layer circuitry 802 may include circuitry for modulation/demodulation, upconversion/downconversion, filtering, amplification, etc. In some embodiments, the processing circuitry 806 of the communication station 800 may include one or more processors. In other embodiments, two or more antennas 801 may be coupled to the physical layer circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (e.g., a computer). For example, the memory 808 may include a computer-readable storage device may, read-only memory (ROM), random- access memory (RAM), magnetic disk storage media, optical storage media, flash-memory devices and other storage devices and media.

In some embodiments, the communication station 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 800 may include one or more antennas 801. The antennas 801 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 800 may include one or more of a keyboard, a display, a non-volatile memory port, multiple antennas, a graphics processor, an application processor, speakers, and other mobile device elements. The display may be an LCD screen including a touch screen.

Although the communication station 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 800 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 800 may include one or more processors and may be configured with instructions stored on a computer-readable storage device memory.

FIG. 7 illustrates a block diagram of an example of a machine 900 or system upon which any one or more of the techniques (e.g., methodologies) discussed herein may be performed. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a power measurement/management device 932, a graphics display device 910, an alphanumeric input device 912 (e.g., a keyboard), and a user interface (UI) navigation device 914 (e.g., a mouse). In an example, the graphics display device 910, alphanumeric input device 912 and UI navigation device 914 may be a touch screen display. The machine 900 may additionally include a storage device (i.e., drive unit) 916, a signal generation device 918 (e.g., a speaker), a network interface device/transceiver 920 coupled to antenna(s) 930, and one or more sensors 928, such as a global positioning system (GPS) sensor, compass, accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)

The power measurement/management device 932 may perform power measurement of received signals from another device. For example, when the access point sends a trigger frame that includes one or more fields, the power measurement/management device 932 may measure the power of at least one of the one or more fields of the trigger frame to determine the power level. The power measurement/management device 932 may estimate the transmit power of the user device by using the result of the power level measurement. The power measurement/management device 932 may set the transmit power of the user device to a value that may be equivalent to the measured power level of the at least one of the one or more fields of the trigger frame.

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine-readable media.

While the machine-readable medium 922 is illustrated as a single medium, the term “machine readable medium” may include a single medium or multiple media (e.g., a centralized or distributed database, and/or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900, and includes digital or analog communications signals or other intangible media to facilitate communication of such software.

According to example embodiments of the disclosure, there may be a device. The device may include a transceiver configured to transmit and receive wireless signals, an antenna coupled to the transceiver, one or more processors in communication with the transceiver, at least one memory that stores computer-executable instructions, and at least one processor of the one or more processors configured to access the at least one memory. The at least one processor of the one or more processors may be configured to execute the computer-executable instructions to identify a trigger frame for resource allocations on an operating channel, received from a computing device, the trigger frame may include one or more fields. The at least one processor of the one or more processors may be configured to execute the computer-executable instructions to measure a power level of a first field of the one or more fields of the trigger frame. The at least one processor of the one or more processors may be configured to execute the computer-executable instructions to determine a transmit power level based at least in part on the measured power level of the first field. The at least one processor of the one or more processors may be configured to execute the computer-executable instructions to cause to send, to the computing device, one or more signals at the transmit power level. The resource allocations may be in accordance with Orthogonal Frequency-Division Multiple Access (OFDMA) standard. The at least one processor of the one or more processors which may be configured to execute the computer-executable instructions to measure the power level may include computer-executable instructions to measure the power level over at least one of one or more frequency bands or a bandwidth of the trigger frame. The one or more fields may include at least one of legacy short training field (L-STF), a legacy long training field (L-LTF), high efficiency short training field (HE-STF), and high efficiency long training field (HE-LTF). The at least one processor of the one or more processors may be further configured to execute the computer-executable instructions to increase the transmit power based at least on one of an out-of-band measurement or a predefined power offset. The resource allocations may be at least one of scheduled resource allocations or random resource allocations. The at least one processor of the one or more processors may be further configured to execute the computer-executable instructions to determine a power level of a channel that is adjacent to the operating channel.

In example embodiments of the disclosure, there may be a non-transitory computer-readable medium storing computer-executable instructions which, when executed by a processor, cause the processor to perform operations. The operations may include identifying a trigger frame for resource allocations on an operating channel, received from a computing device, the trigger frame may include one or more fields. The operations may include measuring a power level of a first field of the trigger frame. The operations may include determining a transmit power level based at least in part on the measured power level of the first field. The operations may include sending, to the computing device, one or more signals at the transmit power level. The resource allocations may be in accordance with Orthogonal Frequency-Division Multiple Access (OFDMA) standard. The operations may include measuring the power level which may include at least one of measuring the power level over one or more frequency bands or measuring the power level over a bandwidth covered by the trigger frame. The one or more fields may include at least one of legacy short training field (L-STF), a legacy long training field (L-LTF), high efficiency short training field (HE-STF), and high efficiency long training field (HE-LTF). The resource allocations may be at least one of scheduled resource allocations or random resource allocations. The operations may further include determining a power level of a channel that is adjacent to the operating channel.

In example embodiments of the disclosure, there may be an apparatus. The apparatus may include at least one memory that stores computer-executable instructions, and at least one processor of the one or more processors configured to access the at least one memory, wherein the at least one processor of the one or more processors may be configured to execute the computer-executable instructions to identify a trigger frame for resource allocations on an operating channel, received from a computing device, the trigger frame may include one or more fields. The at least one processor may be configured to execute the computer-executable instructions to measure a power level of a first field of the one or more fields of the trigger frame. The at least one processor may be configured to execute the computer-executable instructions to determine a transmit power level based at least in part on the measured power level of the first field. The at least one processor may be configured to execute the computer-executable instructions to cause to send, to the computing device, one or more signals at the transmit power level. The resource allocations may be in accordance with Orthogonal Frequency-Division Multiple Access (OFDMA) standard. The at least one processor may be configured to execute the computer-executable instructions to measure the power level which may include at least one of measuring the power level over one or more frequency bands or measuring the power level a bandwidth covered by the trigger frame. The one or more fields may include at least one of legacy short training field (L-STF), a legacy long training field (L-LTF), high efficiency short training field (HE-STF), and high efficiency long training field (HE-LTF).

The at least one processor may be further configured to execute the computer-executable instructions to increase the transmit power based at least on one of an out-of-band measurement or a predefined power offset t. The resource allocations may be at least one of scheduled resource allocations or random resource allocations. The at least one processor may be further configured to execute the computer-executable instructions to determine a power level of a channel that is adjacent to the operating channel.

In example embodiments of the disclosure, there may be a method. The method may include identifying, by a first computing device which may include one or more processors and one or more transceiver components, a trigger frame for resource allocations on an operating channel, received from a second computing device, the trigger frame may include one or more fields. The method may include measuring, by the first computing device, a power level of a first field of the one or more fields of the trigger frame. The method may include determining, by the first computing device, a transmit power level based at least in part on the measured power level of the first field. The method may include causing to send, to the second computing device, one or more signals at the transmit power level. The resource allocations may be in accordance with Orthogonal Frequency-Division Multiple Access (OFDMA) standard. The method may include measuring the power level which may include at least one of measuring the power level over one or more frequency bands or measuring the power level a bandwidth covered by the trigger frame. The one or more fields may include at least one of legacy short training field (L-STF), a legacy long training field (L-LTF), high efficiency short training field (HE-STF), and high efficiency long training field (HE-LTF). The method may further include increasing, by the first computing device, the transmit power based at least on one of an out-of-band measurement or a predefined power offset t. The resource allocations may be at least one of scheduled resource allocations or random resource allocations. The method may further include determining a power level of a channel that is adjacent to the operating channel.

In example embodiments of the disclosure, there may be a wireless communication apparatus. The apparatus may include a means for identifying, by a first computing device which may include one or more processors and one or more transceiver components, a trigger frame for resource allocations on an operating channel, received from a second computing device, the trigger frame may include one or more fields. The apparatus may include a means for measuring, by the first computing device, a power level of a first field of the one or more fields of the trigger frame. The apparatus may include a means for determining, by the first computing device, a transmit power level based at least in part on the measured power level of the first field. The apparatus may include a means for causing to send, to the second computing device, one or more signals at the transmit power level. The resource allocations are in accordance with Orthogonal Frequency-Division Multiple Access (OFDMA) standard. The apparatus may include a means for measuring the power level which may include at least one of a means for measuring the power level over one or more frequency bands or a means for measuring the power level a bandwidth covered by the trigger frame. The one or more fields may include at least one of legacy short training field (L-STF), a legacy long training field (L-LTF), high efficiency short training field (HE-STF), and high efficiency long training field (HE-LTF).

The apparatus may further include a means for increasing, by the first computing device, the transmit power based at least on one of an out-of-band measurement or a predefined power offset t. The resource allocations may be at least one of scheduled resource allocations or random resource allocations. The apparatus may further include a means for determining a power level of a channel that is adjacent to the operating channel.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
a transceiver configured to transmit and receive wireless signals;
an antenna coupled to the transceiver;
one or more processors in communication with the transceiver;
at least one memory that stores computer-executable instructions; and
at least one processor of the one or more processors configured to access the at least one memory, wherein the at least one processor of the one or more processors is configured to execute the computer-executable instructions to:
identify a trigger frame for resource allocations on an operating channel, received from a first device, the trigger frame comprising one or more fields;
measure a power level of a first field of the one or more fields of the trigger frame;
determine a transmit power level based at least in part on the measured power level of the first field; and
cause to send, to the first device, one or more signals at the transmit power level.

2. The device of claim 1, wherein the resource allocations are in accordance with Orthogonal Frequency-Division Multiple Access (OFDMA) standard.

3. The device of claim 1, wherein to measure the power level includes computer-executable instructions to measure the power level over at least one of one or more frequency bands or a bandwidth of the trigger frame.

4. The device of claim 1, wherein the one or more fields include at least one of legacy short training field (L-STF), a legacy long training field (L-LTF), high efficiency short training field (HE-STF), and high efficiency long training field (HE-LTF).

5. The device of claim 1, wherein the at least one processor of the one or more processors is further configured to execute the computer-executable instructions to increase the transmit power based at least on one of an out-of-band measurement or a predefined power offset.

6. The device of claim 1, wherein the resource allocations are at least one of scheduled resource allocations or random resource allocations.

7. The device of claim 1, wherein the at least one processor of the one or more processors is further configured to execute the computer-executable instructions to determine a power level of a channel that is adjacent to the operating channel.

8. A non-transitory computer-readable medium storing computer-executable instructions which, when executed by a processor, cause the processor to perform operations comprising:
identifying a trigger frame for resource allocations on an operating channel, received from a device, the trigger frame comprising one or more fields;
measuring a power level of a first field of the trigger frame;
determining a transmit power level based at least in part on the measured power level of the first field; and
sending, to the device, one or more signals at the transmit power level.

9. The non-transitory computer-readable medium of claim 8, wherein the resource allocations are in accordance with Orthogonal Frequency-Division Multiple Access (OFDMA) standard.

10. The non-transitory computer-readable medium of claim 8, wherein measuring the power level includes at least one of measuring the power level over one or more frequency bands or measuring the power level over a bandwidth covered by the trigger frame.

11. The non-transitory computer-readable medium of claim 8, wherein the one or more fields include at least one of legacy short training field (L-STF), a legacy long training field (L-LTF), high efficiency short training field (HE-STF), and high efficiency long training field (HE-LTF).

12. The non-transitory computer-readable medium of claim 8, wherein the resource allocations are at least one of scheduled resource allocations or random resource allocations.

13. The non-transitory computer-readable medium of claim 8, further includes determining a power level of a channel that is adjacent to the operating channel.

14. An apparatus comprising:
at least one memory that stores computer-executable instructions; and
at least one processor of the one or more processors configured to access the at least one memory, wherein the at least one processor of the one or more processors is configured to execute the computer-executable instructions to:
identify a trigger frame for resource allocations on an operating channel, received from a device, the trigger frame comprising one or more fields;
measure a power level of a first field of the one or more fields of the trigger frame;
determine a transmit power level based at least in part on the measured power level of the first field; and
cause to send, to the device, one or more signals at the transmit power level.

15. The method of claim 14, wherein the resource allocations are in accordance with Orthogonal Frequency-Division Multiple Access (OFDMA) standard.

16. The method of claim 14, wherein measuring the power level includes at least one of measuring the power level over one or more frequency bands or measuring the power level a bandwidth covered by the trigger frame.

17. The method of claim 14, wherein the one or more fields include at least one of legacy short training field (L-STF), a legacy long training field (L-LTF), high efficiency short training field (HE-STF), and high efficiency long training field (HE-LTF).

18. The method of claim 14, further includes increasing, by the first device, the transmit power based at least on one of an out-of-band measurement or a predefined power offset.

19. The method of claim 14, wherein the resource allocations are at least one of scheduled resource allocations or random resource allocations.

20. The method of claim 14, further includes determining a power level of a channel that is adjacent to the operating channel.
